(19) United States
(12) Patent Application Publication
(10) Pub. No.: US 2021/0045472 A1
(43) Pub. Date: Feb. 18, 2021

(54) Joinable and constructable apparel comprising interchangeable and multi-function panels

(71) Applicant: Seyed Farshad Abedinzadeh Kivi, Austin, TX (US)

(72) Inventor: Seyed Farshad Abedinzadeh Kivi, Austin, TX (US)

(73) Assignee: Seyed Farshad Abedinzadeh Kivi, Austin, TX (US)

(21) Appl. No.: 17/036,279

(22) Filed: Sep. 29, 2020

Related U.S. Application Data
(60) Provisional application No. 62/853,048, filed on May 26, 2019.

(51) Int. Cl. A41D 15/04; A41D 27/08; A41D 27/20; A41D 13/11; A42B 1/04; A41D 1/14; A41D 31/02; B32B 7/09; A42B 1/00; B32B 5/26; A45F 5/00; A45C 9/00; A45C 3/00; A62B 18/02; A62B 23/02

(52) U.S. Cl. CPC A41D 15/04; A45F 2200/0516; A41D 27/20; A41D 13/1107; A42B 1/041; A41D 1/14; A41D 31/02; B32B 7/09; A42B 1/006; B32B 5/26; A45F 5/00; A45C 9/00; A45C 3/00; A62B 18/025; A62B 23/025; A41D 2300/32; A41D 2500/52; B32B 2437/04; B32B 2437/00; A41D 27/08

(57) ABSTRACT

The present invention relates to the field of apparel and accessories and particularly to a joinable and constructable apparel comprising interchangeable and multi-functional panels, which can be customized for bearing artwork, patterns, brands, logos, themes or indicia of, for example, locations, luxury brands, sports teams, players and the like and it can be configured to form a variety of apparel accessories like head bands, scarves, arm sleeves, hidden pockets etc.

### FIELD OF THE INVENTION

The present invention relates to the field of apparel and accessories and in one aspect, to customized apparel which bears artwork, patterns, brands, logos, themes or indicia of, for example, sports teams, players, musicians, locations, luxury brands, licensed imagery, comic book characters, and the like.

### BACKGROUND ON THE INVENTION

Functional and buildable apparel is known, including the concept of “modular” clothing as taught in references such as French Patent Publication 2,626,147 filed by Diricq et al (1989). The Diricq reference and other like it discloses a tailoring system in which clothing is manufactured utilizing modular panels related to selected key dimensions of the human frame.

There are all sorts of causes, brands, sports teams, musicians, and countless other interests that people are passionate about and enjoy supporting. One way of doing so is by wearing apparel which depicts brands, logos, themes or indicia representative of these causes, teams or affiliations.

An example of such apparel in sports is when fans purchase a particular sports teams jerseys or hats to show their support and allegiance to that team and/or player. The conflict however lies in the fact that most sports fans are passionate about multiple sports including teams in different sports leagues, eras, players, and even divisions. These fans may wish to represent and endorse their favorite sports leagues, teams and players all at once, something that is not possible on any officially licensed sports merchandise. Furthermore, buying each individual team and or/player apparel would certainly be an expensive proposition.

There are known a variety of sports related clothing items with interchangeable fronts or sides in order to show support for a given team or player. Supporters and fans often wish to support a preferred cause, team or affiliation by way of wearing apparel which depicts brands, logos, themes or indicia representative of such a cause, team or affiliation. One such example in the sporting realm is a jacket of reversible construction such that turning the garment inside-out provides a different look with some such garments displaying different sports teams as part of their two looks. For example, in U.S. Pat. No. 6,550,066, there is disclosed a sports jacket of reversible construction for displaying alternate team and/or player affiliations. The team jacket has different team's sports logos on respective inner and outer surfaces thereof. The jacket may also display the names of players so that the jacket may be reversed to reveal a different player's name and/or number. In this regard, a fan purchases a jacket with one “affiliation” on one side of the jacket and another “affiliation” on the other reversible side the jacket. Only one affiliation is visible at a time.

Other individuals may wish to display luxury or other brand preferences on their apparel, but in a more understated way than the examples noted above, and may be wishing to have more buildable and customizable options in their apparel and accessories.

It is an object of the present invention to obviate or mitigate one or more of the above disadvantages.

### SUMMARY OF THE INVENTION

The present invention provides a modular panel system enabling self-creation of apparel including accessories.

The present invention provides a manner of and system for creating up articles of apparel based on the assembly of a plurality (two or more) of modules/panels, thus allowing the user to create freely according to his/her own liking, functionality needs, type of apparel/accessories and trends of fashion.

According to the invention modular apparel is provided which consists of two or more panels, with each “modular” panel preferably being rectangular in shape and comprising two opposing “long” sides and two opposing “short” ends providing four peripheral edges (one on each side and end of the panel). A panel of rectangular shape can be used to assemble the widest range of customized apparel and accessory items; however, there are a variety of other shapes that may be successfully used as will be hereinafter further described. Along each of four peripheral edges of each panel, there is provided a fastening means, to enable the peripheral edges to be mated with each other or the edges of other second, third, fourth panels etc. . . . in order to form articles of apparel and accessories and the like. An aspect of the invention provides that the fastening means, on at least one side and both ends comprises hook and loop fasteners (for example those patches or strips sold under the trademark Velcro®), and the remaining one side comprises any non-hook and loop fastener, as described further below.

The present invention comprises apparel consisting of a removably connectable panel, wherein the panel comprises two opposing “long” sides and two opposing “short” ends providing four peripheral edges and wherein along each of four peripheral edges of each panel, there is provided a fastening means, to enable the peripheral edges to be mated with each other or the edges of second, third, fourth panels and wherein the fastening means, on at least one side and both ends of the panel comprises hook and loop fasteners and wherein a remaining one side comprises any non-hook and loop fastener.

The present invention comprises apparel and accessories made from one or more of the panels as described herein.

The present invention comprises an article of clothing with a mating fastener hemline for removable attachment of one or more panels, as described herein.

The present invention provides, in another aspect, a method of making dynamically customizable apparel and accessories which comprises conjoining one or more panels, as described herein.

Additional objects and advantages of the invention are set forth in or will be apparent to those of ordinary skill in the art, from the detailed description as follows. Also, it should be further appreciated that modifications and variations to the specifically illustrated and discussed features and materials hereof may be practiced in various embodiments and uses of this invention without departing from the spirit and scope thereof, by virtue of present reference thereto. Such variations may include, but are not limited to, substitutions of the equivalent means, features, and materials for those shown or discussed, and the functional or positional reversal of various parts, features, or the like.

Still further, it is to be understood that different embodiments, as well as different presently preferred embodiments, of this invention, may include various combinations or configurations of presently disclosed features, elements, or their equivalents (including combinations of features or configurations thereof not expressly shown in the figures or stated in the detailed description).

These and other features, aspects and advantages of the present invention will become better understood with reference to the following descriptions and appended claims. The accompanying drawings, which are incorporated in and constitute a part of this specification, illustrate an embodiment of the invention and, together with the descriptions, serve to explain the principles of the invention.

There are numerous and specific advantages of the product of the invention. Primarily, there is provided herein a novel system and means, by way of the panels, to interchangeably and in a whimsical manner create “customized” items and apparel for both functional reasons (for example, creation of a headband, a face mask, a scarf, a body-cam type apparatus, a hidden “pocket”, a sleeve, a bag, a mat or a blanket) and for artistic reasons (for example to displays brands, logos, themes, allegiances, artwork and the like . . . ). It is anticipated that the panels will be joined together by a user for one purpose (for example, creating a carrying bag) and later disassembled for use in another purpose (for example, creating a face mask or hoodie for warmth). The panels are the template or building blocks for endless creation and endless usages. The peripheral edge joining means specifically provide for “3 of the 4 edges” being hook and loop (Velcro) for many reasons. There is maximum holding strength while providing one edge for quick release (needed in some apparel or item constructions). There is an advantage in some apparel instances of not having a firmer Velcro edge near the skin (due to irritation). Lastly, multi-panel mating is easily achievable with the firmer Velcro edges.

These and other objects and advantages of the present invention will become more apparent to those skilled in the art upon reviewing the description of the preferred embodiments of the invention, in conjunction with the figures.

### BRIEF DESCRIPTION OF THE DRAWINGS

The present invention will be better understood and objects apparent when consideration is given to the detailed description herein, made with reference to the annexed drawings wherein:

FIG. 1 is a plan view of a female panel of the invention, with an “X” logo used as an example throughout the set of illustrations to depict the front face of both female and male panels of the invention;

FIG. 1A is a rear view of a female panel of the invention;

FIG. 1C is a perspective view of a user opening the zipper mounted on the back of both male and female panels;

FIG. 2 is a plan view of a male panel of the invention, marked with an “X” logo to represent the front face of the panel;

FIG. 2A is a rear view of a male panel of the invention;

FIG. 3 is a plan view of a pair of panels; female and male, with all the fasteners mated to form one unit, with its boundary sealed off entirely;

FIG. 3A is a perspective view of a user opening a pair of mated panels;

FIG. 3B is a front view of a user placing a mobile device inside a mated pair of panels along the edge with snap buttons connected;

FIG. 4 is a front view of a sectional pairing of one female and one male panel connected along a portion of the fasteners, leaving two sides open and allowing for the two ends of the paired unit to be connected;

FIG. 4A is a perspective view of a user wrapping a unit of sectionally paired panels around his face by taking one open end and wrapping it around the back of his neck to meet the other open end of the unit to close and secure the connection;

FIG. 4B is a perspective view of a user wearing a paired unit of mated female and male panels as a face covering device;

FIG. 5 is a plan view of two female and two male panels connected along the lengthy peripheral edges, leaving all the short-end peripheral edges with hook and loop fasteners open;

FIG. 5A is a perspective view of four mated panels with the long peripheral edges connected together to form a cylindrical device;

FIG. 5B is a perspective view of a user holding a customized carrying bag which was conceived using two female and two male panels connected along every peripheral edge other than the top portion, as to leave an opening;

FIG. 6 is a plan view of two female and two male panels, joined together in a square fashion with all four sides mated;

FIG. 6A is a perspective view of a user wearing four panels mated together in a square configuration as an over-the-shoulder type accessory used to carry a mobile device;

FIG. 7 is a perspective view of user about to wear a sectionally paired unit of panels as a tube-top;

FIG. 7A is a perspective view of a user wearing a sectionally paired unit of panels as a tube-top;

FIG. 8 is a plan view of a sectional pairing of one female and one male panel connected along a portion of the fasteners, leaving two sides open and allowing for the two ends of the paired unit to be connected;

FIG. 8A is a perspective view of a user wearing a sectionally paired unit of panels as headwear;

FIG. 9 is an illustration, in perspective view, of four panels, conjoined in use as a wrap/sarong;

FIG. 10 is an illustration, in perspective view, of two panels mated top-to-bottom, in use, as arm wrap;

FIG. 11 is a perspective view of a user, wearing a shirt with a bottom hemline comprising of a loop fastening band to which a panel, (shown unattached in user's hand) may then be attached, forming pocket;

FIG. 11A is a front view of a shirt with the attached male panel of the invention;

FIG. 11B is a front view of the shirt of FIG. 11A, but wherein the male panel forms a concealed pocket, in accordance with one aspect of the invention;

FIG. 11C is an illustration, in perspective view, showing the back of the male panel of FIG. 11B, with two ends and one side of Hook fasteners and one side of snap buttons (male) being mated to the attachments on the shirt of FIG. 11B, and;

FIG. 12 is a plan view of multiple female and male panels connected side-to-side and top-to-bottom, illustrating the limitless use and extent of modification to overall size of mated panels;

### PREFERRED EMBODIMENTS OF THE INVENTION

A detailed description of one or more embodiments of the invention is provided below along with accompanying figures that illustrate the principles of the invention. As such this detailed description illustrates the invention by way of example and not by way of limitation. The description will clearly enable one skilled in the art to make and use the invention, and describes several embodiments, adaptations, variations and alternatives and uses of the invention, including what we presently believe is the best mode for carrying out the invention. It is to be clearly understood that routine variations and adaptations can be made to the invention as described, and such variations and adaptations squarely fall within the spirit and scope of the invention.

In other words, the invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. Similar reference characters denote similar elements throughout various views depicted in the figures.

This description of preferred embodiments is to be read in connection with the accompanying drawings, which are part of the entire written description of this invention. In the description, corresponding reference numbers are used throughout to identify the same or functionally similar elements. If and when used herein relative terms such as “horizontal,”“vertical,”“up,”“down,”“top” and “bottom” as well as derivatives thereof (e.g., “horizontally,”“downwardly,”“upwardly,” etc.) should be construed to refer to the orientation as then described or as shown in the drawing figure under discussion. These relative terms are for convenience of description and are not intended to require a particular orientation unless specifically stated as such. Terms including “inwardly” versus “outwardly,”“longitudinal” versus “lateral” , “adjacent” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

In the present disclosure and claims, the word “comprising” and its derivatives including “comprises” and “comprise” include each of the stated integers but does not exclude the inclusion of one or more further integers or elements. The terms cords and cording may be used interchangeably.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise. A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise. The terms “a”, “an” and “the” mean “one or more”, unless expressly specified otherwise. The term “plurality” means “two or more”, unless expressly specified otherwise. The term “herein” means “in the present application, including anything which may be incorporated by reference”, unless expressly specified otherwise. The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim. The term “e.g.” and like terms mean “for example”, and thus does not limit the term or phrase it explains.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains.

As used herein “apparel” is to be accorded broad meaning and includes, but is not limited to garments that are worn such as, for example shirts (including tee-shirts, golf shirts, sweatshirts, hoodies, t-shirts, tops, polo shirts, rugby shirts, blouses, undershirts, singlets and jerseys), jumpers, cardigans, pullovers, vests, pants, waistcoats, trousers, jeans, shorts, playsuits, skirts, dresses, socks, bath robes, dressing gowns, nightwear, beachwear, swimwear, bikinis, sarongs, headgear (for example hats and caps), rainwear, jackets, capes, etc. . . . Apparel can also mean accessories such as face masks scarves, hoods, hats, and bandanas. It is to be understood that apparel also include accessories and items such as mats (for example yoga mats), blankets, flags and bags.

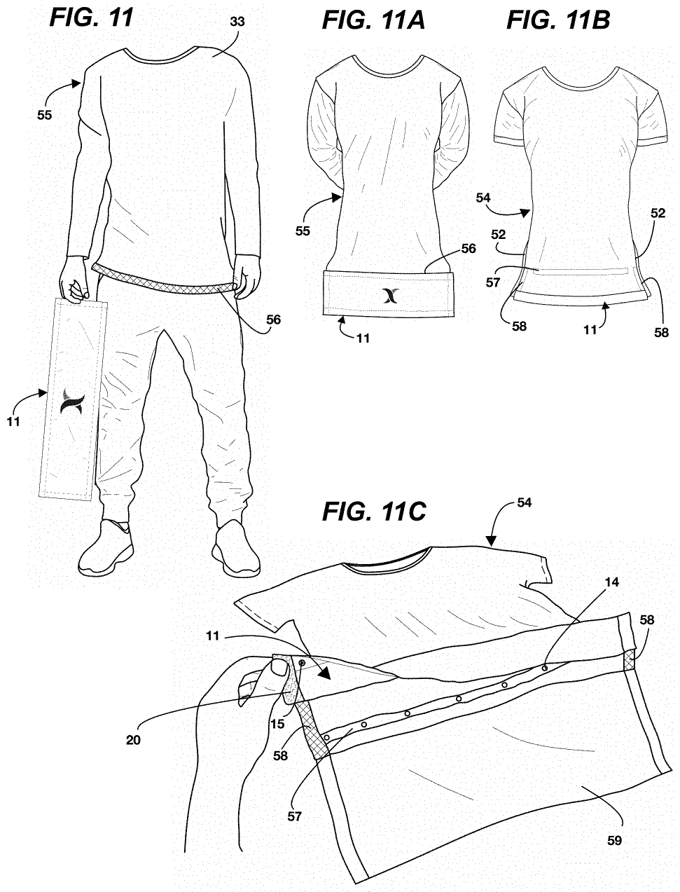

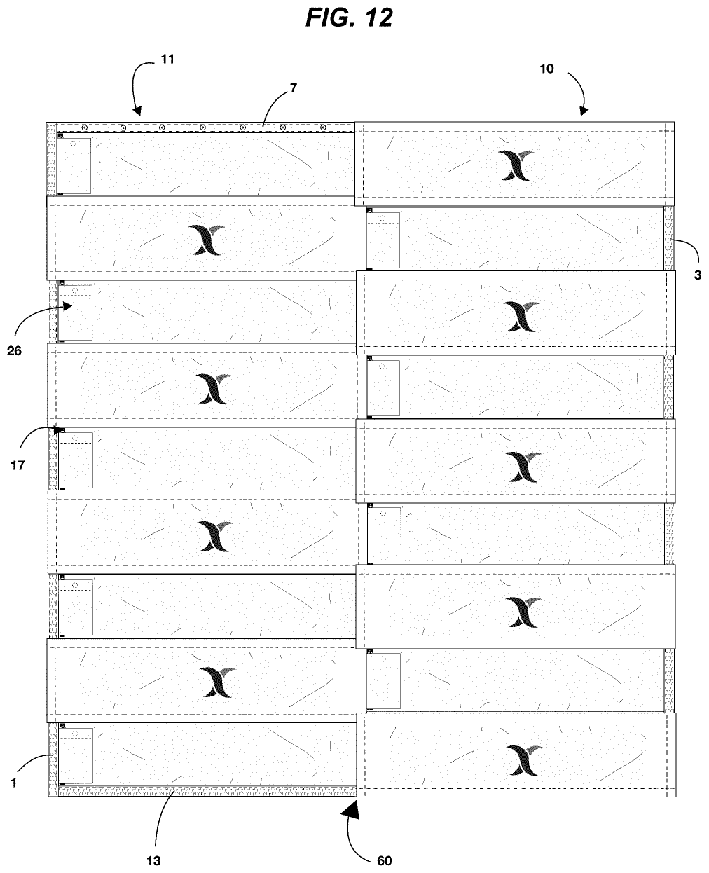

As used herein, the term “panel” is the structure described and claimed and may be used as a single unit (for example attached to a peripheral edge mate-able garment such as a shirt, for example—see FIGS. 11 to 11C) or a panel may form, with two or more other panels, a modular, buildable system to create wearable pieces (such as, for example, hoodies, bandanas, hats, sarongs, arm wraps etc. . . . ). For panels to mate along the peripheral edge which is not hook or loop fastening, appropriately matched male and female fastener parts, on each of two panels, may be required.

The modular panels, forming clothing according to the invention differ from known garments in that they consist of a plurality of interconnected panels which are connected by means of connecting elements to one another releasably. In other words, panels are assembled into modular pieces of clothing using the method described “four edge periphery” fasteners.

In one aspect, the selected fastening means is hidden (either under a material flap or via other fabric concealment modes). In an alternative, the selected fastening means is visible to the eye and may in fact be a prominent feature of the apparel design.

In a preferred form, the panels may comprise and display artwork, patterns, brands, logos, indicia or themes. Brand may refer to luxury marks, trademarks in general or allegiance to a sport's team, a player, a geographic location (for example, city, region, neighborhood, province, state, country), a school (for example high school, college, and university), a league, a product, a service or a cause (for example, religious or political or philanthropic).

The present invention provides a unique modular building system, with a base building block of panels. The potential of what can be created and built with the panel system is almost endless and is specifically versatile due the arrangement of fastening means. It is most preferred that three peripheral edges of each panel (both short ends and one long side) comprise a quick coupling/release hook and loop fastening means such as Velcro® for a tear opening and the “other” long side comprises a secondary non-hook and loop fastening means, including, but not limited to snaps, hook/eye, elastic cords, double-sided tape, magnetic or other mating snaps, buttons, zippers (for example plastic or metal), and slidingly engaging fasteners, (for example heavy duty variants such as Dual Lock™ or Duotec™ or Military Grade Velcro), which feature mushroom shaped stems on each face of the fastener, providing an audible snap when the two faces mate, etc. . . . This arrangement of three edges hook/loop and one edge non-hook/loop has been found to allow the most adaptability and interchangeability in apparel creation.

Furthermore, it is preferred that each panel comprises strip-shaped connecting elements along each edge, the connecting elements comprising the fastening means, as described herein. In use, the fastening means of each conjoined panel are overlapping and releasably attached to each other. Preferably, panels for side/side or end/end connection comprise opposite sides of hook/loop fastening bands and snap button tape sewn onto their respective peripheries. For example, one panel comprises hooks and its conjoinable panel comprises loops on the three edges. One panel would comprise female mating portion of snap on one periphery edge and its conjoinable panel would comprise the male mating portion of the snap on the respective periphery edge. This way, panels are mated for conjoinment, at from one to four attachment edges.

This formation allows a first panel to attach perfectly onto its partner panel, with the hook and loop fasteners on three sides of the rectangular fabric forming an impervious connection, and the buttons of the first panel and its partner panel snapping into each other and closing the opening, if needed.

### Examples of Apparel:

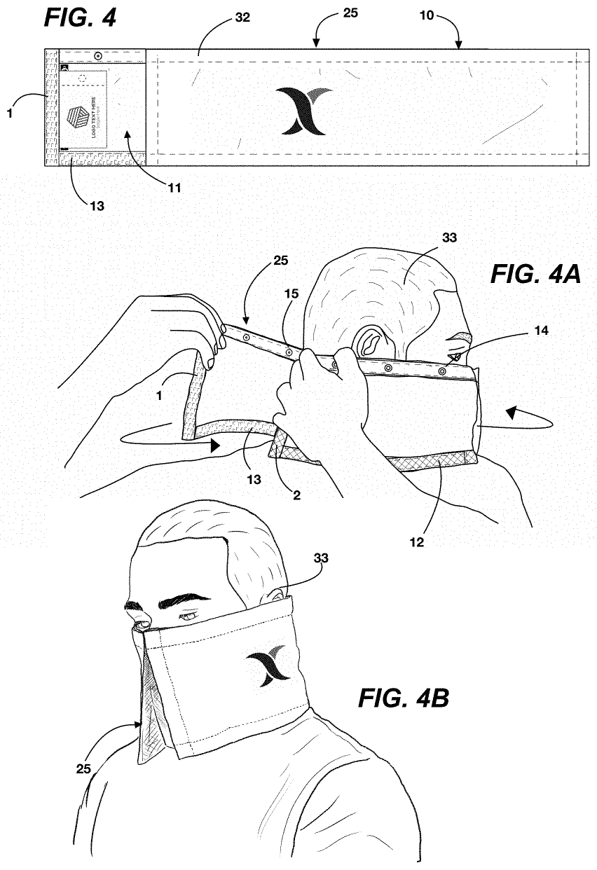

A non-exhaustive list of apparel and accessories is noted above; however, the following uses of the panel system of the invention are of specific interest: face masks, eye masks, bandanas, backpacks, blankets, carrying pouches, cases, wearable garments such as skirts, arm sleeves, haramaki belts, hoodies/hats, neck scarves, etc. . . . . What can be made is limited only by the imagination of the user. For example, a pair of panels, when attached together from side to side (as shown in FIG. 4) can be wrapped around objects to be used as a securing device which sticks and snaps onto itself, forming a sturdy seal.

Along with being a fashion accessory, the panel is also a non-fashion related accessory. Because of the hook and loop fastener, it has the ability to attach onto any material that attracts such hooks. For example, panels can be used on furniture as decorative art, they can be attached onto the ceiling of many vehicles as embroidery and art, they can be wrapped around objects such as books, cellphones, bottles, and anything else which is generally less than 15 inches in width (for standard panels). However, when paired, two panels can form a secure and closed connection around objects.

Furthermore, as one panel tears or becomes damaged, it can simply be replaced while continuing use of remaining non-damaged panels.

It is to be understood that, for example, a user carrying a simple number of 4-5 panels would be able to make and reuse the panels into a variety of desired articles, for example, converting a four-panel carrying bag into a four-panel sarong at the beach. The flexibility, when traveling, of having a selection of panels, convertible into a number of desired, functional articles is highly advantageous. Rough panel requirements might be, for example, for face-masks (2 panels), carrying bags (4 Panels), scarves (4 Panels), wrap around skirts/sarongs (4 Panels), hoodies (4 Panels), bandana (2 Panels), over-the-shoulder sash/carrying case (4 Panels) and up to hundreds of Panels for very large items such as blankets and visual logo backdrops.

Personal preferences can be displayed with imprinted or embroidered images, art, logos and brands, on the panels, as noted below.

### Display of Artwork/Logos etc. . . . :

Panels may comprise artwork or images as described here. If it is desired to conceal the images, for whatever reason, the structure created by the panel can simply be “reversed” and the images then veiled from sight. If a panel is connected to a garment, it may be concealed simply by wrapping it underneath any garment that accepts the panel, veiling the image on the panel, and concomitantly creating a fully functional and secure “hidden” pocket.

### Making Pockets:

Panels may removably attach to garments and have the functionality to be fully exposed or veiled (see FIGS. 11A and 11B), thereby either exposing a view of the panel front (comprising images, art, brands or the like) or may be wrapped underneath any garment that accepts the panel, veiling the image on the panel, and concomitantly creating a fully functional and secure pocket underneath running all the way along the bottom-hem line of the garment.

### Sizes and Shapes of Panels:

While it is most preferred that panels are rectangular, they may also be square or triangular or other geometric shapes. The concept of “building” modular, functional structures using one or a plurality of panels translates easily from small to large. Generally, panel sizes having a length of 6-80″ and width of 3-36″ covers a variety of uses with the scope of the invention. Medium panels may be preferably 4-6″ in width and 20-23″ in length. Larger panels (for blankets, mats and the like) may be preferably 6-9″ in width and 24-28″ in length. Special use panels (for example in creating customized yoga mats) may be, for example, from 20-26″ in width and 35-40″ in length. These dimensions are by way of example only as a high degree of customization of panels is expected, using the core concepts of the invention.

### Panel Materials:

The panels may be formed of a variety of materials including microfiber, mesh, spandex, natural or polymer fabrics such as, for example, cotton, canvas (usually cotton-based), (PVC), synthetic polymers such as polypropylene, nylon, polyvinylchloride and polyester, viscose, elastomers (rubbers); and polychloroprene (also known as neoprene). Thermal and solar material can also be used to manufacture the invention stated herein.

Panels may be dual-layered with an inner layer and outer layer, joined by stitching. In between the inner and outer layers in some embodiments will include an opening to add medical grade materials to be used for filtration such as N95 materials.

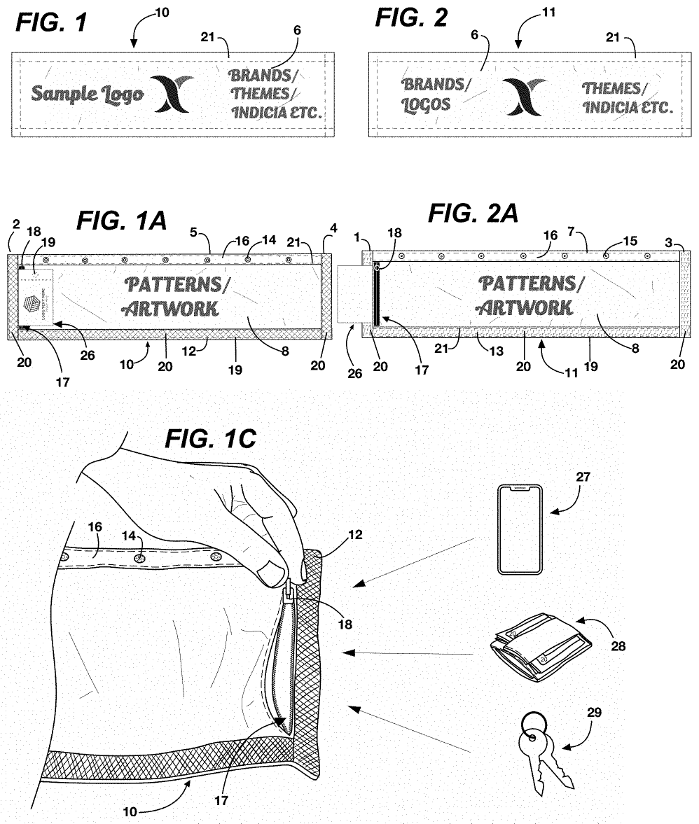

Zippers can also be added to panels of the invention to form a pouch within each individual panel. (see FIG. 1C for details)

### FIGURES

With reference to the figures, the modular panel system of this invention includes essentially a plurality of different panels that can be combined to one another and used for creating apparel and accessories, by uniquely connecting them by fastening means as those shown in FIGS. 1 to 12. Further in regards to the figures, the illustrations of the panels of the invention are based off a standard size of each panel being twenty two inches wide, comprising of hook and loop fasteners as well as a band of snap buttons which hold seven buttons placed 2.5 inches apart and leaving a two-inch gap in-between each snap button. The Panels of the invention can subsequently be sized smaller or larger and comprising of snap button bands with more or less than seven snap buttons. For purposes of consistency, all panels of the invention illustrated in figures herein are designated to be one standard size.

Turning to the figures wherein like numerals represent the same features.

FIG. 1 is a plan view of the front of panel 10 comprising of two layers of textile materials or other suitable and flexible materials, one layer on the front side of 10 and another layer on the opposing back side of 10 with fasteners lined and sewn along the periphery of the opposing side to form a geometric structure with visible stitch lines 21. Both front and back sides of 10 can have artwork depicting a specific logo, brand, theme, or indicia and throughout the Figures illustrated herein a stylized “X” logo will be used to characterize the front face of panels of the invention.

FIG. 1A is a plan view of the back of panel 10 showing two sides (5 and 12) and two ends (2 and 4). Two ends 2 and 4 and one side 12 comprising loop fastening band (illustrated using crosshatch lines to indicate loop fastening) along peripheral edge band 20 and one side 5 comprises band 16 equipped with seven snap buttons 14 (female). Two sides and two ends are sewn onto textile material 8 with the stitch lining around the peripheral edge of panel 10 while top-stitch 21 is used to sew both sides and end bands from back of panel 10 to front textile layer 6. The close-ended zipper 17 is sewn next to one end of a fastening band of panel 10 and runs between the two side bands (5 and 12) with pull tab 18. Credit Card sized pocket 26 with one snap button 19 for closing pocket sewn along one end of loop band and on top of zipper 17.

FIG. 1C is a perspective view of panel 10 and user opening the close-ended zipper 17 using pull tab 18 and a front view of items that can be stored within the opening of 17 on panel 10 including a mobile device 27, a wallet 28, and a set of keys 29.

FIG. 2 is a plan view of the front of panel 11, identical to panel 10 of the invention, which comprises of two layers of textile materials or other suitable and flexible materials, one layer on the front side of 11 and another layer on the opposing back side of 11 with complementary fasteners to Panel 10 of the invention lined and sewn along the periphery of the opposing side to form a geometric structure with visible stitch lines 21. Both front and back sides of 11 can have artwork depicting a specific logo, brand, theme, or indicia and throughout the Figures illustrated herein a stylized “X” logo will be used to characterize the front face of panels of the invention.

FIG. 2A is a plan view of the back of panel 11 showing two sides (7 and 13) and two ends (1 and 3). Two ends 1 and 3 and one side 13 comprising hook or military grade injection hook fastening band (illustrated using tiny hook lines to indicate hook fastening) along peripheral edge band 20 and one side 7 comprises band 16 of snap buttons 15 (male). Two sides and two ends are sewn onto textile material 8 with the stitch lining around the peripheral edge of panel 11 while top-stitch 21 is used to sew both sides and end bands from back of panel 11 to front fabric layer 6. The close-ended zipper 17 is sewn next to one end of the fastening band of panel 10 and runs between the two side bands (7 and 13) with pull tab 18. Credit Card sized pocket 26 sewn along one end of hook band and rests on top of zipper 17.

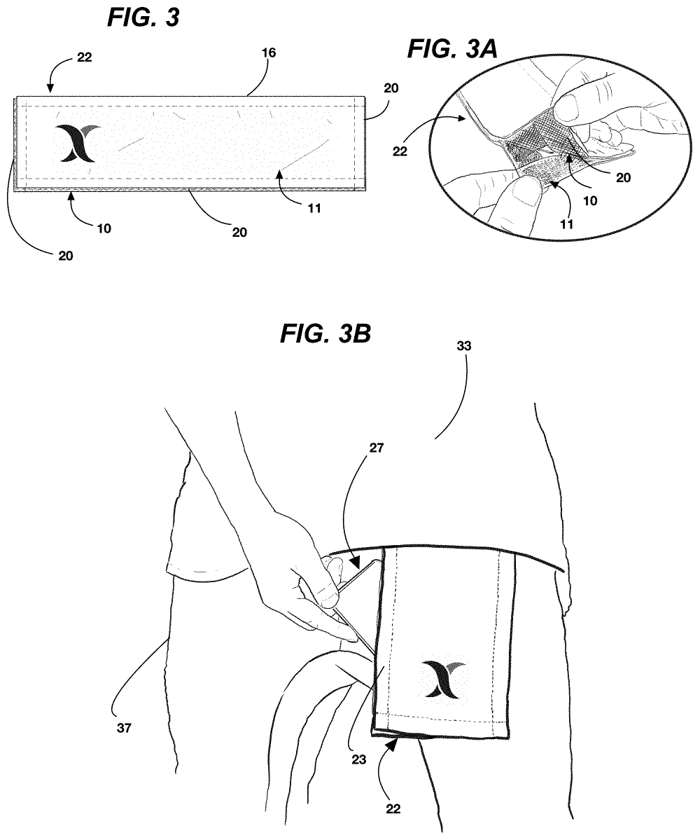

FIG. 3 is a plan view of two panels (10 and 11) mated 22 along each respective peripheral edge. This unity forms an enclosure with three sides along peripheral edge 20 completely sealed and one side along peripheral edge 16 sealed shut with gaps in between every snap button connection.

FIG. 3A is an expanded sectional view of mated panels 22 being opened at one end of their peripheral edge along band 20.

FIG. 3B is a perspective view of a user wearing a pair of mated panels 22 tucked into his pants and using the fastened unit as a carrying device. In this illustration the peripheral edge equipped with snap buttons is facing the inner thigh and with just one of the snap buttons 23 open the user is able to slide his mobile device 27 into the enclosure. The peripheral edge facing the outer thigh, as well as the two ends along peripheral edge 20 in FIGS. 3 and 3A are completely sealed with the hook from the male panel and the loop from the female panel mated, however due to the size of the gap between the snap buttons, it is not recommended to put smaller items such as loose change inside this joined pouch because when the user is in motion those items may slip out from between the gaps.

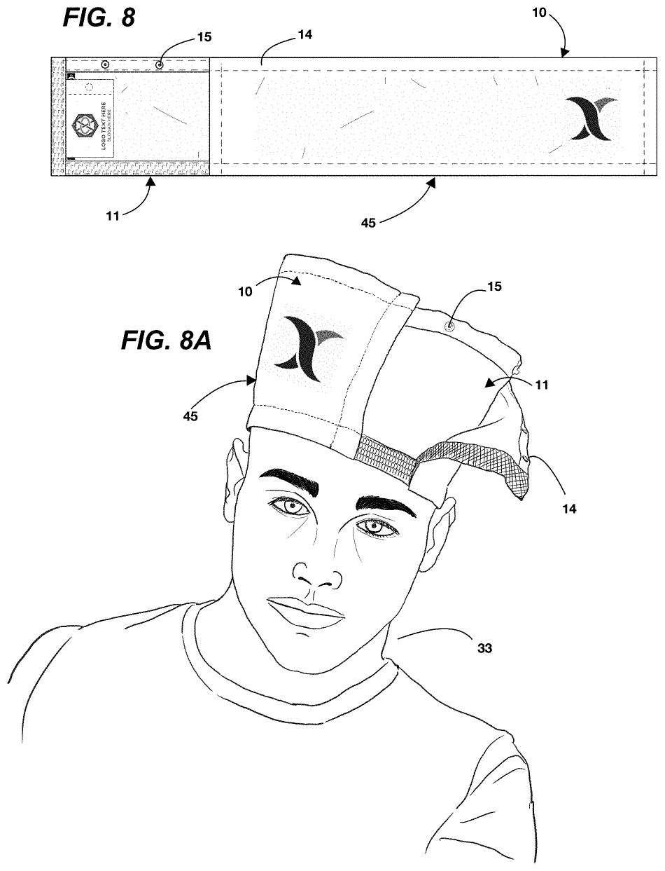

FIG. 4 is a plan view of panel 10 connected to six snap buttons of panel 11. There are seven snap buttons on each respective panel and depending on the desired usage of the mated panels, the paired device can be either fully mated 22 or connected along any of the seven snap buttons. For Example, connecting 4 female snap buttons from 10 to 4 male snap buttons from 11 will leave 3 button on each panel open and allow the user to wrap the mated panels around his/her face and connect the open buttons together as shown in FIG. 4A to form a Face-Mask generally shown as 25. Moreover, if only 1 button is connected from each panel as shown in FIG. 8, leaving 6 buttons open on each individual panel, this allows for a different application altogether because the device can now be wrapped around a bigger object as there are more buttons that are open.

FIG. 4A is a perspective view of user 33 wrapping a unit of sectionally paired panels around his face by taking one open end and wrapping it around the back of his neck to meet the other open end of the unit to close and secure the connection by conjoining the remaining male snap buttons 15 to the open female snap buttons 14, as well as the open hook bands 1 and 13 to the open loop bands 2 and 12.

FIG. 4B is a perspective view of user 33 wearing panels as a Face-Mask generally shown as 25.

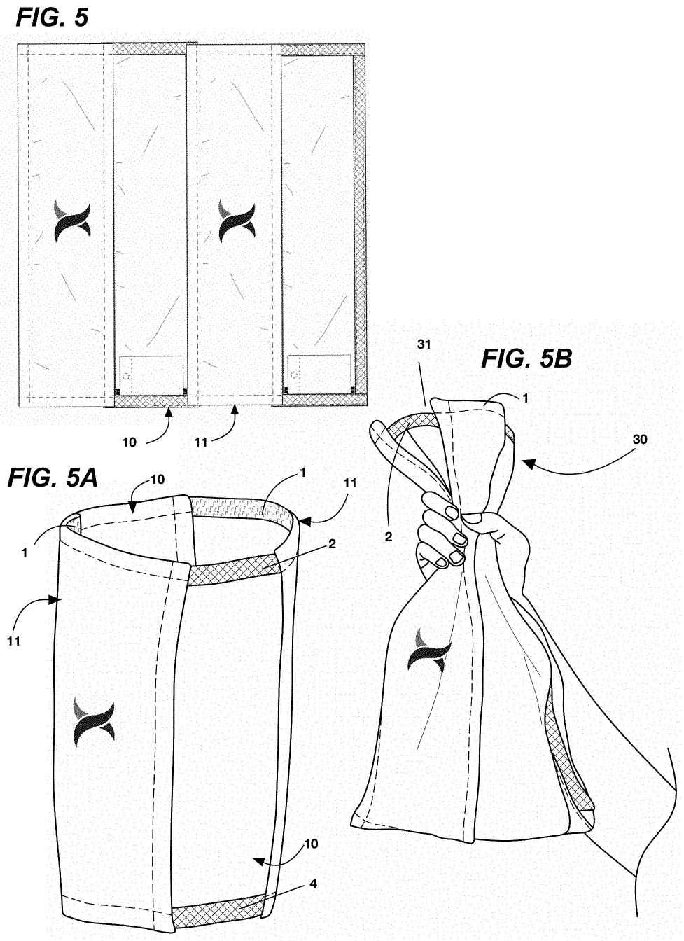

FIG. 5 is a plan view of two female and two male panels connected along the lengthy peripheral edges, leaving all the short-end peripheral edges with hook and loop fasteners open;

FIG. 5A is a perspective view of four mated panels with the long peripheral edges connected together to form a cylindrical device, leaving hook and loop bands 1 and 2 on top end as well as 3 and 4 on bottom end open.

FIG. 5B is a perspective view of a user holding the conjoined panels in FIG. 5A and mating the bottom hook and loop ends together as to form a customized carrying bag, generally shown as 30. The fastening bands 1 and 2 on the top end are left unattached, allowing for an opening 31.

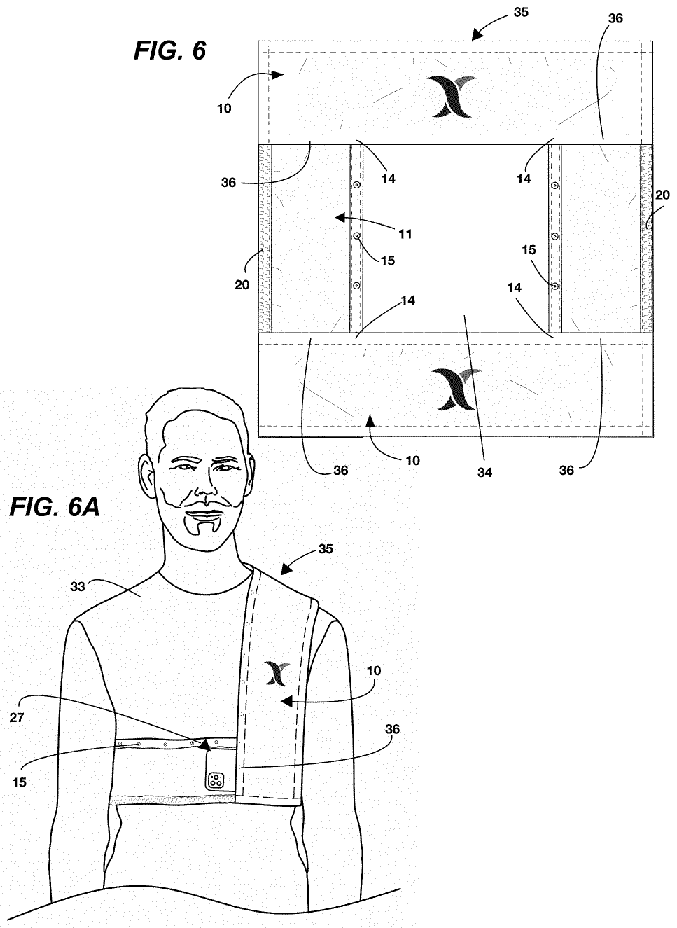

FIG. 6 is a plan view of two female and two male panels, conjoined at all four short ends along peripheral hook and loop band 20, forming a square shape with an opening in the center 34. Four female snap buttons 14 will match up with four male snap buttons 15 to further secure the connection between the panels in this configuration. In addition, there are four snap buttons 36 left open which allow for an attachment, for example a mobile device in a case equipped with a snap button that will connect with the open snap button 36 as illustrated in FIG. 6A.

FIG. 6A is a perspective view of a user wearing four panels mated together in a square configuration as an over-the-shoulder type accessory and used to carry a mobile device to record video. The square four-panel configuration is worn by user 33 by placing one arm and his head through the opening 34 as illustrated in plan view of FIG. 6. By using a customized case which is equipped with a single snap button sewn onto the back of said case or by using a snap button with an adhesive backing, a mobile device placed inside said carrying case can be connected to one of the four open complementary snap buttons 36 on the over-the-shoulder accessory generally shown as 35. Furthermore, orientation of mobile device can be either landscape or portrait depending on which arm the user wishes to wear 35 on.

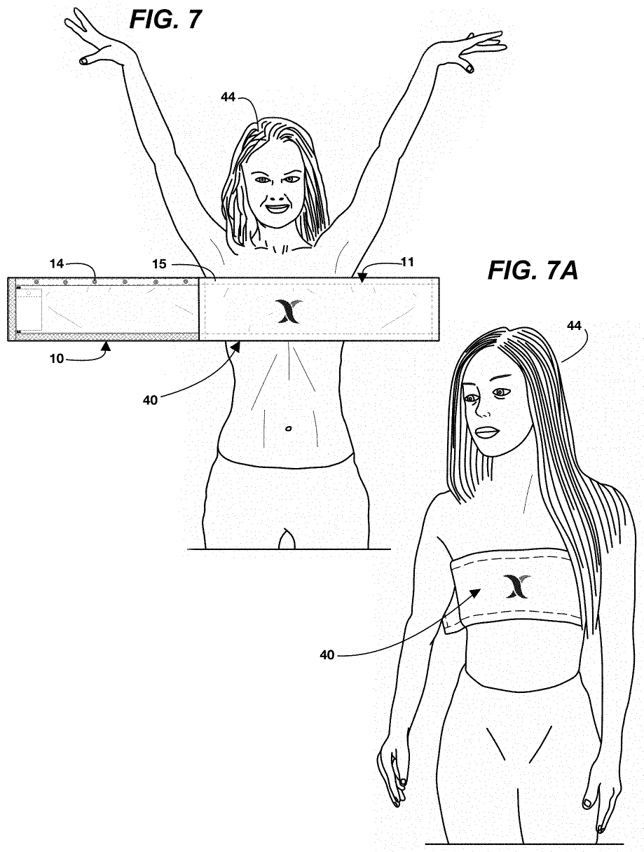

FIG. 7 is a perspective view of how user 44 would conjoin a pair of panels and wear them as a tube-top, generally shown as 40. Sectionally pairing the unit at only one snap button 15 on the standard size panel as illustrated in FIGS. 1 through 12 will give user up to forty inches of coverage and six open snap buttons to be wrapped around rib cage and mated onto the reciprocal snap buttons on the complementary panel.

FIG. 7A is a perspective view of user 44 wearing a pair of panels mated together to form a Tube-Top generally shown as 40.

FIG. 8 is a plan view of a sectionally paired unit of panels with five snap buttons 14 on panel 10 connected to five snap buttons 15 on panel 11, leaving two male snap buttons on 11 open and two snap buttons on 10 open and ready for pairing.

FIG. 8A is a perspective view of user 33 wearing the sectionally paired male and female panel unit as a type of headwear, generally shown as 45. The user can adjust the style of 45 in many different ways to achieve a desired look including folding the unit in half and wearing it like a bandana, flipping the arrangement around in multiple ways to show different sides of the panels, connecting snap buttons 14 from panel 10 to corresponding snap buttons on panel 11 or mismatching them to really customize look and fit of 45.

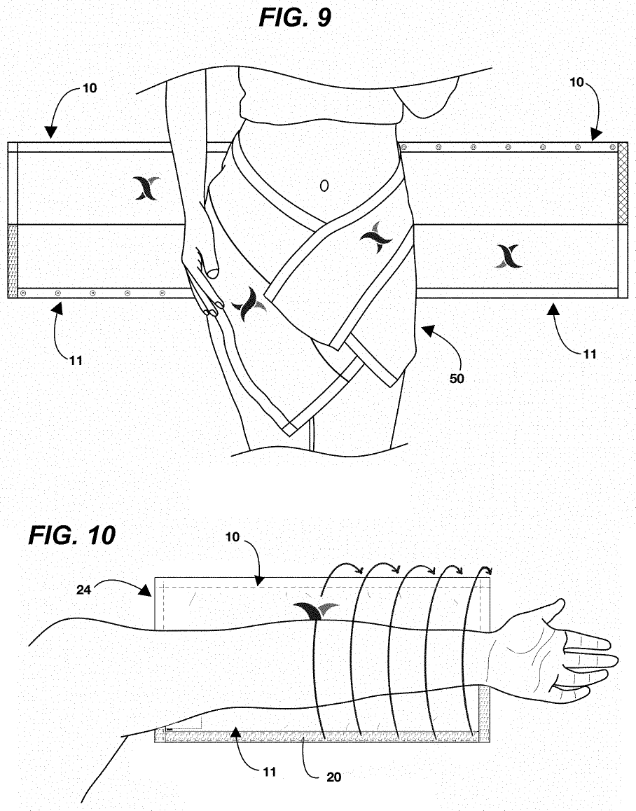

FIG. 9 is a perspective view of user wearing a sarong or skirt generally shown as 50 using four panels. One pair of female and male panels conjoined top-to-bottom connected at one end to a second pair of male and female panels conjoined top-to-bottom will create enough coverage to be wrapped around the hips.

FIG. 10 is a perspective view of two panels shown behind users arm, which are mated top-to-bottom along the peripheral edge with snap buttons. The panels can then be folded inward towards each other and over users arm to conjoin at the hook and loop bands 20. This configuration creates a type of arm sleeve, generally shown as 24 which can be worn underneath apparel or on top to achieve desired look.

FIG. 11 is a perspective view of user 33, wearing custom shirt 55 comprising a Velcro hemline 56 to which panel 11 may then be attached. This mating between apparel and a panel of the invention is for several reasons. 1) The shirt with complementary panel attachments will typically be blank without any labels or logos, the artwork, brand, logo, theme or indicia that would normally be on the shirt can now be printed (via sublimation or other digital printing methods) onto the panels and give the user the option of interchangeability with regards to design. User can have multiple panels with different designs and can interchange them depending on outfit suitability and color coordination. 2) Attaching a panel to a shirt with complementary fastening capabilities allows the user the option of displaying the panel fully when connected to the bottom hemline of the shirt as illustrated in FIG. 11A, or 3) to tuck the panel in and under the shirt, which would then only display the top portion of the panel (up to the stitch line) instead of the full panel as in FIG. 11A and furthermore, the tucked in panel can be connected to the corresponding snap button attachments sewn underneath the shirt to create a concealed inner pocket the width of the shirt and panel.

FIG. 11A is a front view of shirt 55 with attached panel 11 at hemline 56 which gives the user the ability to have multiple panels with different images and interchange the design and artwork he or she would like to display.

FIG. 11B is a front view of short-sleeved shirt 54, but wherein panel 11 forms a detachable and concealed inner pocket, in accordance with one aspect of the invention. The way to achieve this style is by connecting the snap buttons on the panel of the invention to the snap buttons 57 on the shirt which are only visible when looking inside the shirt as referenced in 57 illustrated in FIG. 11C. The connection achieves the function of an inner pocket by way of securing and sealing the three peripheral loop band sides of the panel (20 in FIG. 2A) to the three hook bands sewn onto the shirt (56 on FIGS. 11 and 58 on FIGS. 11B and 11C) as well as having the fourth peripheral side with snap buttons attached to the snap buttons affixed on the shirt. When shirt is worn and panel is fully mated to the shirt, the snap buttons will be facing upright permitting user to place items within the conceived inner pocket without having them falling out.

FIG. 11C is a perspective view of shirt 54, illustrating the means to attach panel 11 to inner bottom hemline 56 of shirt 54. Furthermore, snap buttons 15 on panel 11 are shown mating snap buttons 57 which comprise of female snap buttons 14 on shirt 54, hook Velcro strips 20 on panel 11 mating with loop Velcro strips 58 on shirt 54. Shirts with attachments that allow pairing with a panel of the invention will typically have a slit the length of the short side of the panel on the sides as illustrated in FIG. 11B reference 52 which allows the separation of the front and back of the shirt. On the illustrated shirt 54 the back 59 has no attachments for pairing with panels of the invention, however these custom shirts can be made to have complementary panel attachments on front side as shown in illustrations 11 to 11C, on the back side or both.

FIG. 12 is a plan view of multiple Panels 10 and 11 mated to form a blanket, generally shown as 60. In this example, Panels 10 are front-facing and Panels 11 are showing the back-side where 1 is the hook fastening band on one side of 11, and 3 is the hook fastening band on the opposite side. If they were to be flipped over it would be vice-versa with the front side of 11 displayed and the back side of 10. An assembled blanket or backdrop has no limitations on the number of additional panels that can be mated to make an even larger object. The sample in FIG. 13 has 18 Panels connected, however the open bands along the top 7 and bottom 13 will continue to allow for further enhancements vertically to the overall size of 60. Furthermore the open bands on either side 1 and 3 will allow for additional panels to be connected and enhance the overall size of 60 horizontally. Also visible on FIG. 13 are the tags 26 and zippers 17 which are equipped onto each individual panel.

I claim:

1. Apparel comprising:
at least two removably connectable rectangular panels, wherein each panel comprises two opposing “long” sides, and two opposing “short” ends providing four peripheral edges; and
fastening means, provided at the said peripheral edges of each of the said rectangular panels, for enabling the said peripheral edges to be mated with each other;
wherein,
the said fastening means, on at least one side and both ends of the said panel comprises hook and loop fasteners and the remaining one side comprises any non-hook and loop fastener.

2. The apparel of claim 1, wherein, a first panel comprising loop fastening bands along the said peripheral edges of one side and two ends and female snap button on the second side and a second panel comprising hook fastening bands along the edges of one side and two ends and male snap button on the second side, thereby enabling functional and flexible interconnection of the said two panels.

3. The apparel of claim 1, wherein, a modular system of articulated functional accessories and apparel comprises a first portion of female connectable panels and a second portion of male connectable panels wherein a) a female portion comprising a functional malleable panel with a set of loop fastening bands and female/socket snap buttons and artwork of a brand, logo, theme or indicia; b) a male portion comprising a functional malleable panel with a set of hook/injection mold fastening bands and male/stud snap buttons and artwork of a brand, logo, theme or indicia; c) conjoining the female and male panels allows for a plurality of functional wearable accessories and articles of clothing with elements of each female portion of artwork, logo, brand, theme or indicia and each male portion of artwork, logo, brand, theme or indicia.

4. The apparel of claim 3 wherein the logo, brand, theme or indicia comprises any sign of allegiance.

5. The apparel of claim 1, wherein, the rectangular panels is made from materials including microfiber, mesh and spandex.

6. The apparel of claim 1, wherein, the rectangular panels is made from natural fabrics including cotton, cotton based canvas.

7. The apparel of claim 1, wherein, the rectangular panels is made from synthetic polymers including polypropylene, nylon, polyvinylchloride and polyester, viscose, elastomers, polychloroprene, thermal and/or solar materials.

8. The apparel of claim 1, configured to form an apparel accessory comprising a removably connectable rectangular panel, wherein the said panel comprises two opposing “long” sides and two opposing “short” ends providing four peripheral edges and wherein along each of four peripheral edges of each panel, there is provided fastening means, to enable the peripheral edges of the said panel to be mated with fasteners on the garment hemline and the band of hook or loop fasteners on the garment, the garment comprising a bottom horizontal hemline, such hemline comprising a row of fastening means and a vertical seam, comprising at least a band of hook or loop fasteners.

9. The apparel of claim 6, wherein the front surface of the said rectangular panel may be viewable below the bottom hemline of the garment or tucked into the underside of the garment, forming a hidden pocket.

10. The apparel of claim 1, comprising two rectangular panels and configured to form a face-mask

11. The apparel of claim 8, wherein, medical grade materials for filtration of pollutants is added in between the inner and outer layers through an opening, to configure the panels as masks.

12. The apparel of claim 1, comprising two rectangular panels and configured to form arm sleeves for layered warmth and displaying artwork.

13. The apparel of claim 1, comprising two rectangular panels configured to form headwear.

14. The apparel of claim 1, comprising four rectangular panels, configured to form a skirt for wrapping around the waist and sticks and snaps closed to secure the ends together.

15. The apparel of claim 1, comprising four rectangular panels, configured to form a carrying bag by fastening all the four panels in a top to bottom configuration and snapping the very top of the first Panel to the very bottom of the fourth Panel.

16. The apparel of claim 1, wherein the said rectangular panels is dual-layered with an inner layer and outer layer, joined by stitching.

17. The apparel of claim 1, wherein the fastening means is at least any one of hook or loop fastening bands, snaps, hook/eye, elastic cords, double-sided tape, magnetic snaps, buttons, zippers and slidingly engaging fasteners.

18. A method of making immensely customizable and functional accessories and articles of clothing by having two or more panels affixed in a variety of forms and configurations.
